(19) United States
(12) Patent Application Publication
(10) Pub. No.: US 2012/0278708 A1
(43) Pub. Date: Nov. 1, 2012

(54) VERIFYING CONFIGURATIONS

(76) Inventors: THOMAS JESUDASAN, Bangalore (IN); Senthil Gopalan, Bangalore (IN)

(21) Appl. No.: 13/098,481

(22) Filed: May 1, 2011

(51) Int. Cl. G06F 17/28

(52) U.S. Cl. 715/256

(57) ABSTRACT

Various embodiments of systems and methods for verifying configurations are described herein. Attributes, inputs, and technical descriptors of one or more configurations are received in response to configuring operations performed by a user on one or more user interfaces. The received technical descriptors are converted into natural language words. A report to enable reading of the configurations is generated. The report comprises a coherent arrangement of the received attributes, the received inputs, and the converted technical descriptors. The generated report is presented on a user interface.

### FIELD

The field relates generally to configurations performed on a computer system. More particularly, the field relates to a method for verifying configurations.

### BACKGROUND

Organizations have several internal functions and almost all such functions can be computerized. Enterprise application systems enable computerization or automation of organizational functions. A user can navigate through user interfaces of an enterprise application and can perform configurations by using operations such as select, enter, edit, create, etc, on the user interfaces. An example of an organizational function is a payroll function. Using an appropriate application, a person responsible can configure employee entitlements according to existing payroll policies of an organization. Entitlements can be specific to an employee, a group of employees, or status of employees and such entitlements are configured in accordance with policies. Once configured, the entitlements are recorded in a system and payouts can be made to employees. Similarly, configurations for other organizational functions can be performed and recorded in a respective system.

There can be numerous configurations for any given organizational function or process. These configurations may not be permanent and may need to be modified. Incorrect configurations can give rise to many problems such as, for example, erroneous payouts to employees. Also, a user may need to navigate through multiple user interface windows to perform a configuration. Therefore, a configuration can be spread across several windows and it may not be practically possible to verify whether the configuration is correct without creating sufficient test data and testing each configuration. Such testing could be very time consuming and laborious. Any change in configurations also requires substantial re-testing. Easily verifying configurations performed in a system, without the need for testing would be desirable.

### SUMMARY

Various embodiments of systems and methods for verifying configurations are described herein. Attributes, inputs, and technical descriptors of one or more configurations are received in response to configuring operations performed by a user on one or more user interfaces. The received technical descriptors are converted into natural language words. A report is then generated to enable reading of the configurations. The report comprises a coherent arrangement of the received attributes, the received inputs, and the converted technical descriptors. The generated report is presented on a user interface.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a method for verifying configurations, according to one embodiment.

FIG. 2 illustrates a first user interface of a configuration process, according to one embodiment.

FIG. 3 illustrates a user interface for creating attributes, according to one embodiment.

FIG. 4 illustrates a user interface showing a list of entitlements, according to one embodiment.

FIG. 5 illustrates a user interface for assigning attributes to the entitlements, according to one embodiment.

FIG. 6 illustrates a user interface for creating decision cases, according to one embodiment.

FIG. 7 illustrates a user interface for creating validation criteria, according to one embodiment.

FIG. 8 illustrates a report that is presented on a user interface, according to one embodiment.

FIG. 9 illustrates another report that is presented on a user interface, according to one embodiment.

FIG. 10 shows a policy document as an example.

FIG. 11 is a block diagram of an exemplary computer system according to one embodiment.

### DETAILED DESCRIPTION

Embodiments of techniques for verifying configurations are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

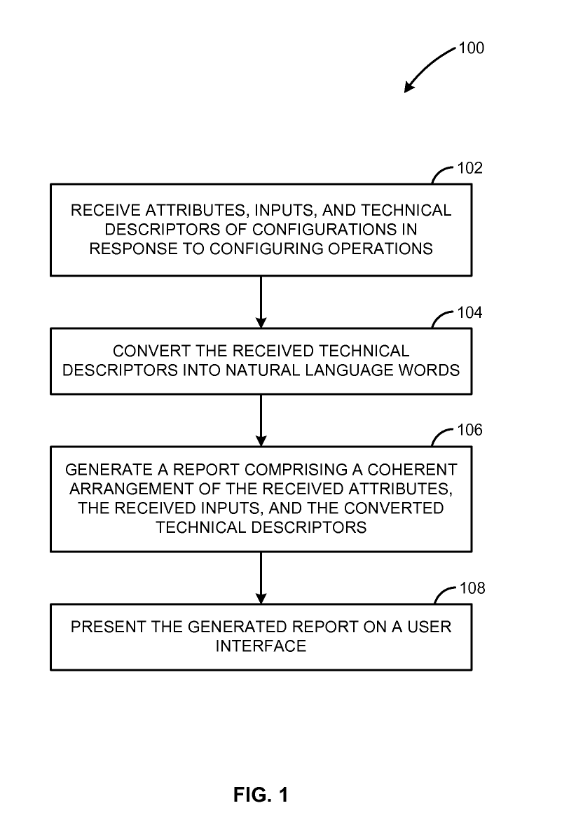

FIG. 1 illustrates an embodiment of a method for verifying configurations 100. Enterprise resource planning (ERP) application systems can be used for configuration of organizational functions such as a finance function or a payroll function. The configurations can be about entitlements of employees or any kind of eligibilities or criteria for payouts to suppliers, vendors, etc. The method is explained in reference to configuration of a payroll function related to employee entitlements. Several configuring operations are required to be performed by a user for configuration of entitlements. Depending on the type of application, a user may need to navigate through a plurality of user interface windows and perform operations such as, for example, create, edit, or delete operations, on relevant user interface windows for configuring entitlements. A user is often required to perform configuring operations based on a policy document of an organization or any rule or guideline document. The configurations in the system should reflect the guidelines in the policy.

At 102, in response to the configuring operations performed by a user, attributes, inputs, and technical descriptors of the configurations are received. The process of configuration of entitlements includes configuration of validation criteria. A validation criterion is a condition that should be satisfied to be partly eligible for an entitlement. Several validation criteria may need to be satisfied to be eligible for an entitlement. Each validation criterion is associated with one or more attributes. An attribute can be any parameter with respect to an entitlement. For example, an attribute can be a parameter that is used to define an eligibility condition for an entitlement. Examples of parameters include ‘age of the employee,’ ‘number of years of service,’ ‘last appraisal rating.’ Value for the attributes may be directly stored in the system or may need to be derived using a logic. For example, attributes such as ‘work location’ or ‘date of joining of the employee’ can be stored in a ERP system and attributes such as ‘number of years of service’ or ‘age of the employee’ need to derived using a logic. ‘Number of years of service’ can be derived by date of joining and ‘age of the employee’ can be derived from date of birth of the employee that is stored in the system.

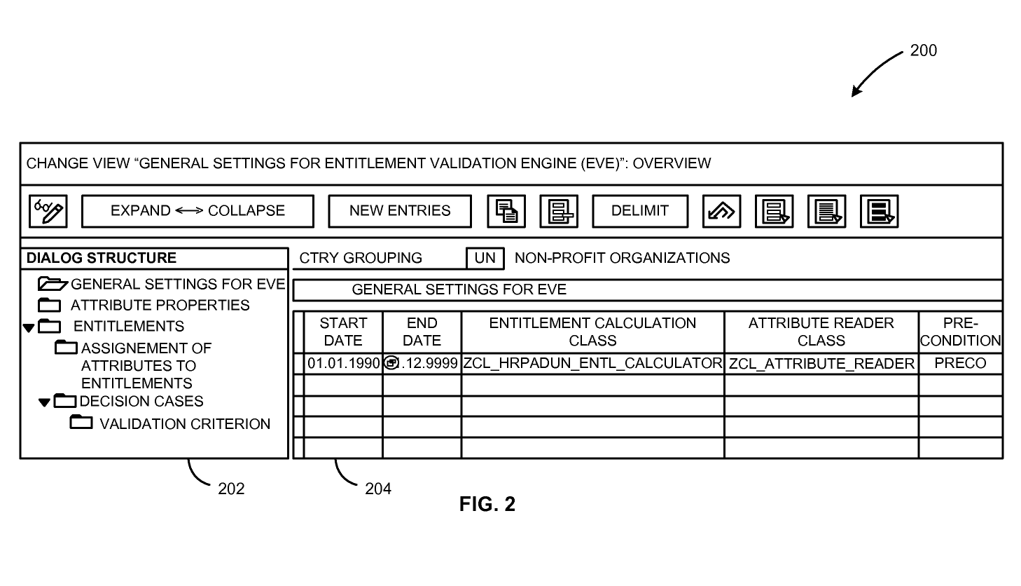

Technical descriptors can be broadly defined as operations that are used to establish logic for configuring entitlements. Technical descriptors vary depending on the type of configuration application. The user interface can have fields dedicated for these technical descriptors. The technical descriptors include any logical operations. Logical operations can include Boolean operators such as ‘AND,’ ‘OR,’ and ‘NOT.’ Logical operations can also include operators that are used to establish logic for selecting values for a validation criterion. An embodiment for performing configuring operations and associated technical descriptors are explained in reference to FIGS. 2-7.

For configuring a validation criterion, a user can perform configuring operations by first selecting attributes. Inputs corresponding to the selected attributes and technical descriptors are then specified by the user. Inputs can be typed or selected from a dropdown menu. A user can be provided with a series or a cluster of user interfaces (e.g. a view cluster) to perform such configuring operations. In one embodiment, depending on the type of the entitlement, one or more of the configured validation criteria need to be satisfied to be eligible for an entitlement. In another embodiment, a group of validation criteria can belong to a decision case. All the validation criteria in the decision case should be satisfied to satisfy a decision case. There can be more than one decision case for an entitlement and at least one decision case should be satisfied to become eligible for an entitlement.

At 104, each technical descriptor is converted into a corresponding interpretable natural language word. In one embodiment, the technical descriptors are converted into the English language. Technical descriptors play a vital role in configurations. A technical descriptor represents logic with respect to a configuration. Each configuration application can have its own set of technical descriptors. But a technical descriptor in itself may not be readily interpreted. Therefore, a technical descriptor is converted into English by using one or more English words. The converted technical descriptor is in plain English and can be interpreted by any person with knowledge of the English language.

Consider a validation criterion which requires that the values of an attribute (such as an ‘allowance’) should be within a two values. For configuring this validation criterion, a relevant technical descriptor can be an “include” operator. The “include” operator is a logical operator used for selecting inputs for an attribute (e.g., ‘allowance’). Under this operator, inputs can be about selection of values such as ‘selection of a range of values’ starting from a high value to a low value. In one embodiment, “include” operator is converted into “SHOULD BE,” which can be easily interpreted in conjunction with attributes and inputs without the need to know the details or function of the “include” operator. In one embodiment, natural language words for all the technical descriptors of a configuration application are created and stored in a repository (e.g. a database associated with the configuration application). When the technical descriptors are received, the received technical descriptors are mapped with the repository to convert them into their respective natural language words.

At 106, a report is generated using the received attributes, the received inputs, and the converted technical descriptors. A user can be provided with an option on a user interface of the configuration application to generate the report. The received attributes, the received inputs, and the converted technical descriptors are coherently arranged such that the configurations can be read. The coherent arrangement includes a plurality of coherent sequential arrangements. Each sequential arrangement represents a validation criterion. A sequential arrangement includes an attribute followed by a corresponding converted technical descriptor and a corresponding input. Such arrangement of an attribute followed by a corresponding converted technical descriptor and a corresponding input is similar to a sentence and can be readily deciphered by any one reading the arrangement. Consider the following example of a sequential arrangement with respect to mobility allowance entitlement:

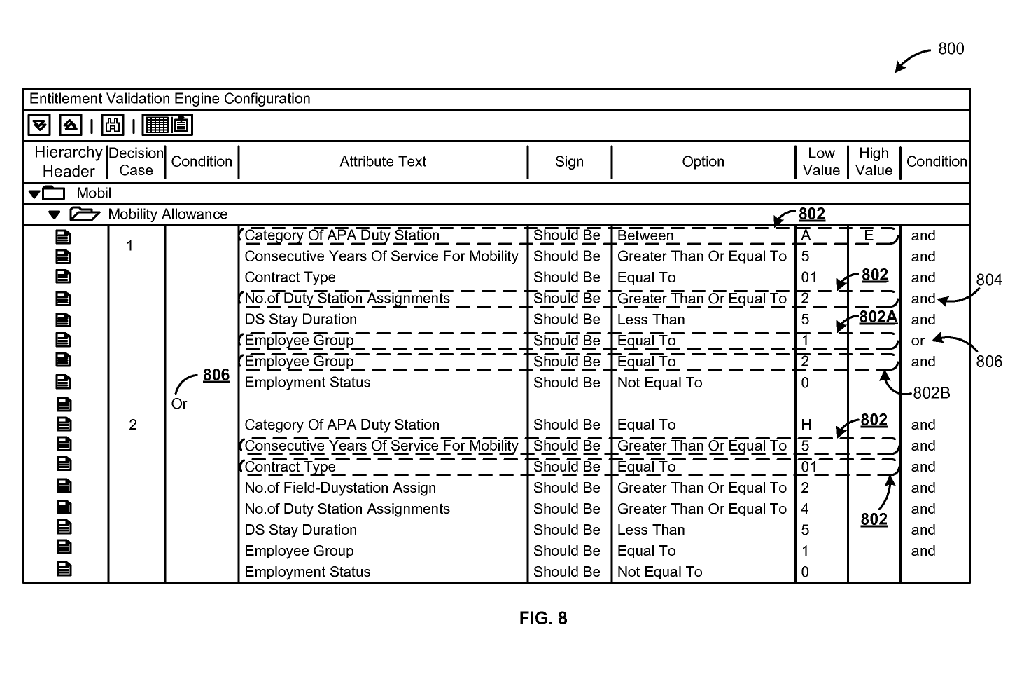

‘CONSECUTIVE YEARS OF SERVICE’ is an attribute, ‘SHOULD BE’ is a converted technical descriptor (e.g., INCLUDE operator), and ‘GREATER THAN OR EQUAL TO’ and ‘5 YEARS’ are inputs associated with the technical descriptor. This sequential arrangement is coherent in that it is almost like a sentence and can be easily interpreted by anyone having the knowledge of the English language. This sequential arrangement corresponds to one validation criterion that is configured by a user using the configuration application. Since the entitlements are configured in view of the policy, there will be a statement in the policy regarding the eligibility of the mobility allowance. By reading such sequential arrangement, a corresponding configuration can be read and checked whether the configuration is in accordance with the policy. The report includes several such sequential arrangements to represent the validation criteria for the entitlements. The level of coherency should be such that the configurations can be easily interpreted by reading the sentence-like sequential arrangements. A more detailed example of coherent arrangement is described in reference to FIGS. 8-10.

At 108, the generated report is presented on a user interface. A new user interface window can be opened on top of the configuration application for presenting the report. The report is in plain English and the configurations can be readily verified. A user who performed configuring operations can read the report and check the configurations. A policy owner can also access the report and verify whether the configurations are in accordance with the current policy. Configurations can be verified by any person who may or may not have the knowledge about the configuring application. Since the configurations can be read directly from the report, the process of verifying configurations is enhanced because there is no need to create test data or run test scripts. Also, a report can be compared with a policy document and any errors can be noticed and pin pointed. Any errors can be traced to a particular attribute of an entitlement and associated configuration. A user can access that attribute using the configuration application and edit the relevant configuration to fix the errors.

FIG. 2 illustrates a user interface 200 of an entitlement configuration application. The configuration application is used to configure payroll-related entitlements of an organization. The configuration application can be referred to as Entitlement Validation Engine. As an example, a Non-profit Organization is considered. The user interface 200 is an initial user interface and the starting point of configuration of payroll entitlements. The user interface has a left pane 202 which includes a hierarchical index. By selecting a field in the hierarchical index of the left pane 202, a corresponding set of fields is presented in a right pane 204. Configuring operations are performed by selecting a field in the left pane 202 and then performing configuring operations in corresponding fields on the right pane 204. After making a general setting in the first user interface 200, a user can select a subsequent field, i.e. ‘Attribute Properties’ field, in the left pane 202. A right pane corresponding to the Attribute Properties' field is then rendered. It should be noted that this is one way for performing configuring operations. Other user interface techniques and layouts can be used for the configuration application. For example, a new user interface window can be opened for each field of the left pane 202. The entries made in general settings are technical in nature such as, for example, class for calculating entitlement amount, class for reading attributes, etc. Pre-conditions can also be maintained in the general settings. A pre-condition is an attribute that is common across all entitlements. For example, an employee will be eligible for any entitlement only if he/she is an ‘active’ employee in the system. Since this condition is common across all entitlements, this attribute is maintained at a header (general) level rather than separately for each entitlement.

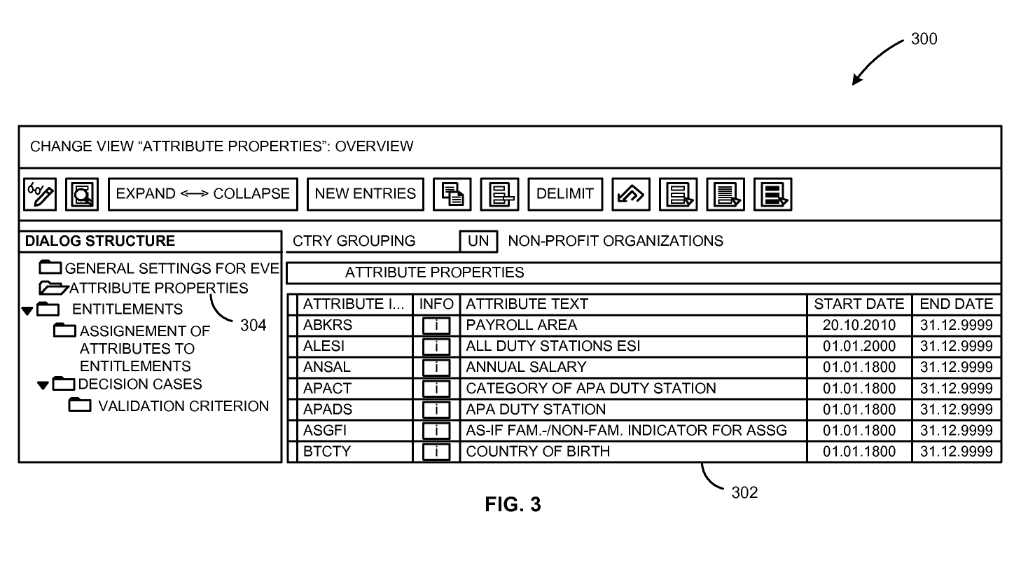

FIG. 3 illustrates a user interface 300 with a right pane 302 corresponding to the ‘Attribute Properties’ field 304. Attributes can be created using this user interface 300. Each attribute include a corresponding identifier. For example, the identifier ‘ABKRS’ corresponds to the attribute ‘payroll area.’ Several such identifiers are used in the configuration process instead of displaying the entire attribute text. This way of using identifiers is common in ERP applications such as SAP® ERP applications (products of SAP AG, Germany). A configuring user can just type the identifier instead of typing the entire attribute text. A list of identifiers of the attributes and a list of corresponding attribute texts are shown in the right pane 302. Properties of attributes such as start date and end date can also be set for the attributes. Entitlements are configured after creating attributes relevant to the payroll.

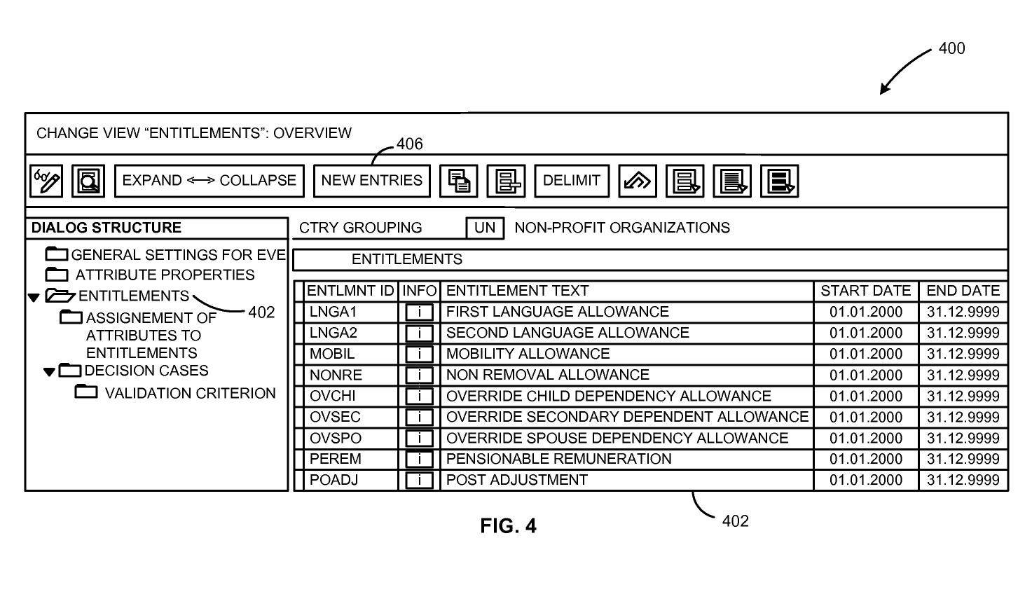

FIG. 4 illustrates a user interface 400 with a right pane 402 corresponding to the entitlements field 404. A list of entitlements is presented in the right pane. Each entitlement is also represented by an identifier. For example, the entitlement “pensionable remuneration” is represented by the identifier “PEREM.” An entitlement is created by selecting ‘New Entries’ button 406. A relevant user interface can then be rendered. For example, if the entitlement “Mobility Allowance” is created, a user interface to configure the “Mobility Allowance” is presented to a user.

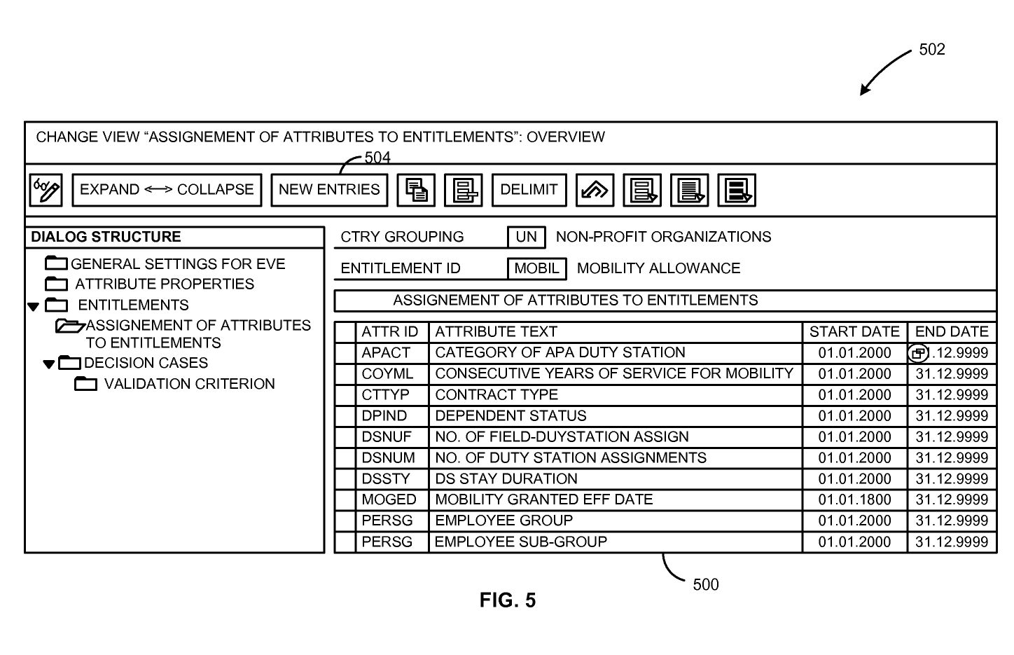

Referring to FIG. 5, a right pane 500 for configuring the “Mobility Allowance” is rendered on the user interface 502. The first step in configuring an entitlement is assignment of attributes to the entitlement. Since the “Mobility Allowance” is selected, attributes are assigned to the “Mobility Allowance” using fields in the right pane. The right pane 500 shows a list of attributes that are created as explained in reference to FIG. 3. A user can select an attribute and assign it to the entitlement “Mobility Allowance” using ‘New Entries’ button 504.

After assigning attributes to the entitlement, the validation criteria for the entitlement are configured. There can be several validation criteria for each entitlement. Depending on the entitlement, all or combinations of some of these validation criteria have to be satisfied to be eligible for an entitlement. In one embodiment, groups of validation criteria are configured for each entitlement. Each group of the validation criteria can be referred to as a decision case. Therefore, before configuring a group of the validation criteria, a decision case corresponding to that group is created.

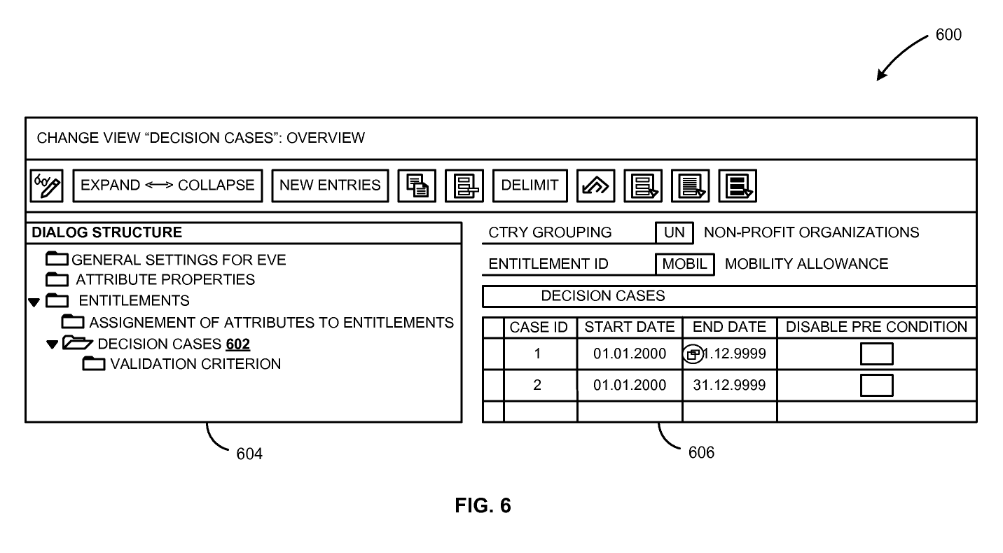

FIG. 6 illustrates a user interface 600 for creating a decision case. The “decision case” field 602 in the left pane 604 is selected to render a right pane 606. Decision case identification numbers (1, 2, 3, etc.) can be used for creating a decision case. A decision case is created by assigning a decision case identification number (1, 2, 3, etc.) and by assigning properties such as validity period or preconditions. Validation criteria are then created for each decision case.

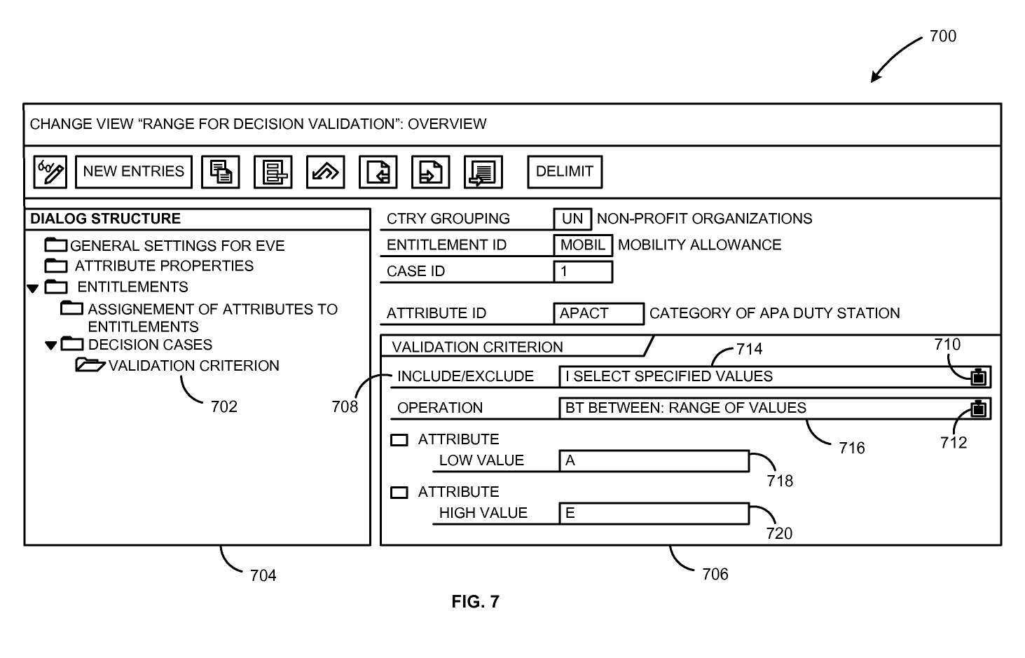

FIG. 7 illustrates a user interface 700 for creating a validation criterion for a decision case. The configuring user can select the “validation criterion” field 702 in the left pane 704 to render the right pane 706 for creating the validating criterion. An entitlement ID, a decision case ID, and an attribute ID are displayed in the right pane based on the selections made in the left pane. For example, the entitlement ID ‘MOBIL’ represents ‘Mobility Allowance,’ a decision case ID ‘1’ represents ‘Decision case 1,’ and an attribute ID ‘APACT’ represents the attribute ‘Category of APA Duty Station.’ Duty stations for an organization (e.g. Non-Profit Organizations) can be categorized as Field Duty Stations and Head Quarter Duty Stations. Field Duty Stations can be further categorized as ‘A’ to ‘E’ based on their hardship factor, with ‘A’ being a place where living conditions are relatively better and ‘E’ being a place where living conditions are bad. Head-quarter Duty Stations can be represented by H and can include places such as, for example, Geneva, Paris, N.Y.

The right pane 706 also includes an ‘include/exclude’ operator 708. A dropdown menu 710 can be provided in one or more fields corresponding to the ‘include/exclude’ operator 706. A user can select an option from the dropdown menus 710 and 712. In this case, the option ‘select specified values’ is selected for a first field 714 from the dropdown menu 710. An option ‘exclude specified values’ is also provided in the dropdown menu 710. The option ‘select specified values’ corresponds to ‘include’ operator and the option ‘exclude specified values’ corresponds to ‘exclude’ operator. An option ‘Between: Range of values’ can be selected for a second field 716. The user can then input a low value and a high value in respective fields, 718 and 720. If an option ‘Greater than or equal to’ is selected in the second field 716, then only a single input field can be presented to enter a value. After entering the low and high values, the validation criterion with respect to the attribute ‘APACT’ is complete. A user can then type a new attribute for the ‘Mobility allowance’ and create another validation criterion. Similarly, validation criteria associated with the ‘decision case 1’ and the one or more attributes that are assigned to the ‘Mobility allowance’ are configured. This completes the configuration of a decision case 1 for the ‘Mobility allowance.’ Decision case 2 and other decision cases for the ‘Mobility allowance’ can also be configured in similar way.

After configuring the ‘Mobility allowance,’ a user can select another entitlement (as explained in FIG. 4). The selected entitlement can be configured using the process described in reference to FIGS. 5-7, e.g., by assigning attributes to entitlements, creating decision cases, and creating validation criteria. All entitlements of a payroll function can be configured similarly. As can be seen from the above described configuration process, there can be numerous conditions that need to be configured for an entitlement. Typically, configurations are verified by creating test data and running test scripts using the test data. This process of verifying is time consuming. The method for verifying configuration generates a readable report to verify these configurations, thereby eliminating the need to create and run tests.

FIG. 8 shows a report 800 that is presented on a user interface. The report 800 includes a coherent arrangement comprising a plurality of sequential arrangements 802. The blocks with broken line patterns are only for the purpose of highlighting some sequential arrangements 802 and are not presented in the report 800. Each sequential arrangement 802 includes an attribute followed by a corresponding converted technical descriptor and corresponding inputs. Each sequential arrangement 802 corresponds to a validation criterion. Based on the validation criterion of the “mobility allowance” that is associated with an attribute ‘APACT’ (as explained in reference to FIGS. 2-7), the corresponding sequential arrangement, as shown in the report 800, includes: “CATEGORY OF APA DUTY STATION SHOULD BE BETWEEN A AND E”

The technical descriptor ‘include/exclude’ operator is converted into ‘should be should not be.’ If an option corresponds to the ‘include’ operator, then the ‘include’ operator is converted into ‘should be.’ If an option corresponds to the ‘exclude’ operator, then the ‘exclude’ operator is converted into ‘should not be.’ The terms ‘Between,’ A′ (a low value), and ‘E’ (a high value) are the inputs and ‘category of APA duty station’ is an attribute. Similarly, the report includes other sequential arrangements corresponding to other validation criteria for “mobility allowance” entitlement. The order of an attribute, a corresponding converted technical descriptor, and corresponding inputs makes the sequential arrangement 802 coherent. The arrangement “CATEGORY OF APA DUTY STATION A AND E” is not coherent in that it may not be interpreted by a person without thorough knowledge of the configurations.

A group of sequential arrangements represent a decision case. For the mobility allowance, there are several validation criteria for a decision case. As described in reference to FIG. 7, after configuring validation criterion with respect to the attribute ‘APACT,’ validation criterion with respect to other attributes are similarly configured. The user creates validation criterion (of a decision case) for one attribute after another. In such case, the technical descriptor is a logical condition about the combination of configured validation criteria that have to be satisfied. This logical condition can be converted into a natural language word “AND.” Each sequential arrangement in a decision case is therefore connected to another sequential arrangement in the same decision case using “AND” 804, implying that validation criteria within a decision case have to be satisfied in conjunction to be eligible for an entitlement.

If an attribute is repeated in two or more validation criteria within a decision case, it means that only one of those validation criteria should be satisfied. This logic is converted into a natural language word “OR.” The sequential arrangements corresponding to those validation criteria are connected using ‘OR’ 806. For example, consider that an employee is eligible for an entitlement if the employee group is ‘1’ or ‘2.’ Two validation criteria can be configured corresponding to the attribute ‘employee group.’ A first validation criterion is configured by selecting the attribute ‘employee group’ and providing ‘1’ as an input. A second validation criterion can then be configured by selecting the same attribute ‘employee group’ and providing ‘2’ as an input. The sequential arrangements 802A and 802B corresponding to these validation criteria are connected using ‘OR’ 806. Similarly, the decision cases are also connected with a word that represents a logical condition such as ‘OR’ 806 when the decision cases need to be satisfied only in alternative. Without the “AND” and “OR” connecting the sequential arrangements, the report 800 as a whole may not be comparable with a policy.

In one embodiment, the report is presented as a table-like arrangement comprising rows and columns (as shown in FIG. 8). Each sequential arrangement is presented in a single row. Each column is assigned a name. The column names include decision case, attribute text, sign, option, low value, high value, and conditions. The decision case numbers are provided in the decision case column. Attribute texts are provided in the attribute text column. The converted technical descriptor is provided in the sign column. The user inputs are provided in the option column, low value column, and high value column. The logical column is provided in the condition column. A user reading the report can therefore easily identify the category to which the words of the sequential arrangements belong to. In another embodiment, the sequential arrangements can be provided without any column names. For example, a sequential arrangement can be presented as “CATEGORY OF APA DUTY STATION SHOULD BE BETWEEN A LOW VALUE A AND A HIGH VALUE E”.

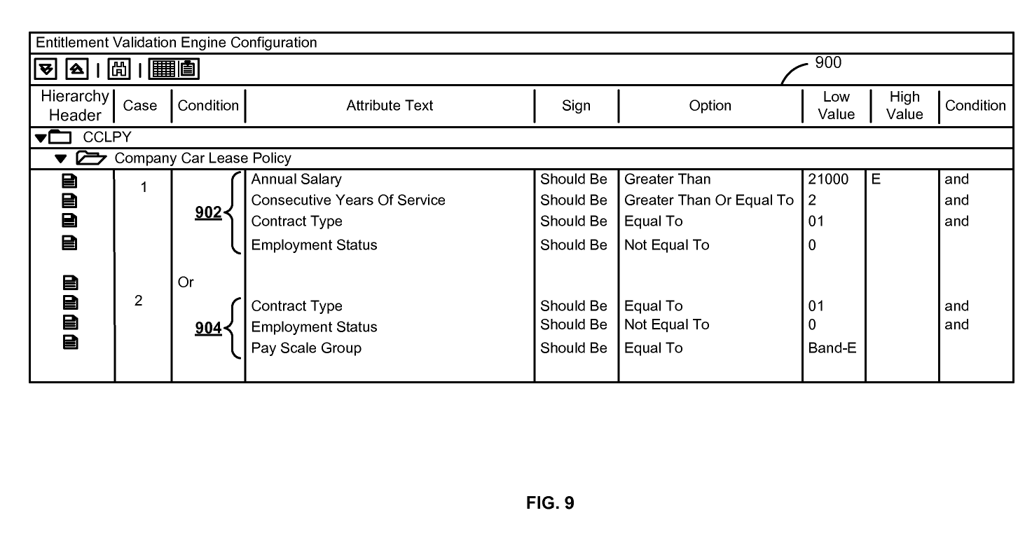

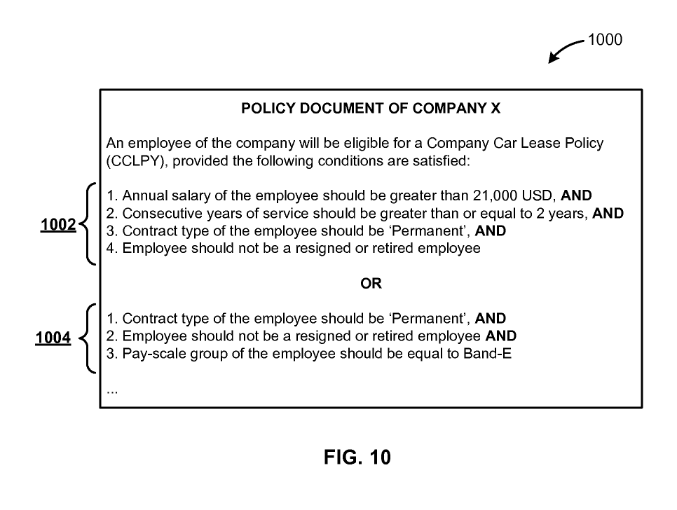

FIG. 9 shows another report 900 that is presented on a user interface. The report 900 is generated to read configurations of “Company Car Lease Policy” entitlement (CCLPY). This entitlement is configured based on a policy 100 that is shown in FIG. 10. The generated report 900 can be easily interpreted and compared with the policy 1000. For example, referring to FIGS. 9 and 10, a configured validation criterion that is presented as the first sequential arrangement “ANNUAL SALARY (an attribute) SHOULD BE (a technical descriptor) GREATER THAN (an input) 21,000 USD (an input)” can be easily compared with the first point of the policy 1000 that reads “1. Annual salary of the employee should be greater than 21,000 USD.” The configuration of this validation criterion can be readily checked and any errors can be easily pointed out. Similarly, other sequential arrangements in the report 900 can be compared with the relevant points in the policy 1000 to check the correctness of configurations. A set of sequential arrangements and associated logical conditions can be used for verifying configuration of decision cases. For example, sequential arrangements 902 that belong to a decision case ‘1’ and associated logical conditions (and, or, etc) can be compared with a decision case consisting of first set of points 1002 in the policy 1000. Similarly, sequential arrangements 904 belonging to a decision case ‘2’ and associated logical conditions (and, or, etc) can be compared with a decision case consisting of second set of points 1004 in the policy 1000. The report 900 is therefore comparable with the policy 1000 and is useful in checking whether the configurations are in accordance with the policy 1000.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

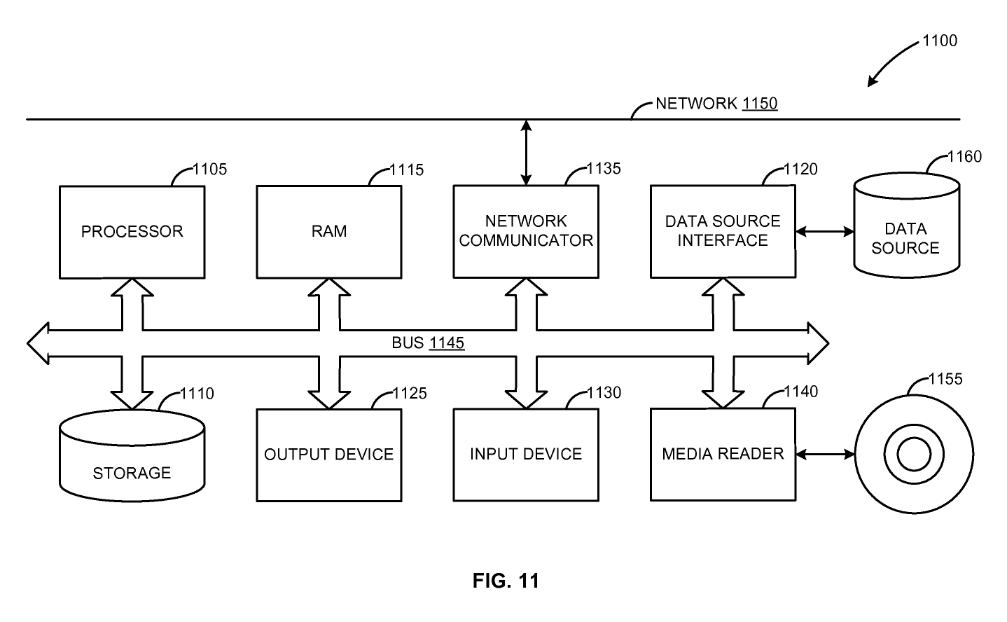

FIG. 11 is a block diagram of an exemplary computer system 1100. The computer system 1100 includes a processor 1105 that executes software instructions or code stored on a computer readable storage medium 1155 to perform the above-illustrated methods of the invention. The computer system 1100 includes a media reader 1140 to read the instructions from the computer readable storage medium 1155 and store the instructions in storage 1110 or in random access memory (RAM) 1115. The storage 1110 provides a large space for keeping static data where at least some instructions could be stored for later execution. The stored instructions may be further compiled to generate other representations of the instructions and dynamically stored in the RAM 1115. The processor 1105 reads instructions from the RAM 1115 and performs actions as instructed. According to one embodiment of the invention, the computer system 1100 further includes an output device 1125 (e.g., a display) to provide at least some of the results of the execution as output including, but not limited to, visual information to users and an input device 1130 to provide a user or another device with means for entering data and/or otherwise interact with the computer system 1100. Each of these output devices 1125 and input devices 1130 could be joined by one or more additional peripherals to further expand the capabilities of the computer system 1100. A network communicator 1135 may be provided to connect the computer system 1100 to a network 1150 and in turn to other devices connected to the network 1150 including other clients, servers, data stores, and interfaces, for instance. The modules of the computer system 1100 are interconnected via a bus 1145. Computer system 1100 includes a data source interface 1120 to access data source 1160. The data source 1160 can be accessed via one or more abstraction layers implemented in hardware or software. For example, the data source 1160 may be accessed by network 1150. In some embodiments the data source 1160 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive attributes, inputs, and technical descriptors of one or more configurations in response to configuring operations performed by a user on one or more user interfaces;
convert the received technical descriptors into natural language words;
generate a report comprising a coherent arrangement of the received attributes, the received inputs, and the converted technical descriptors to enable reading of the configurations; and
present the generated report on a user interface.

2. The article of manufacture of claim 1, wherein the coherent arrangement comprises a plurality of sequential arrangements, where each sequential arrangement comprises an attribute followed by a corresponding converted technical descriptor and corresponding inputs.

3. The article of manufacture of claim 2, wherein one or more of the converted technical descriptors are used to establish a relation between the plurality of sequential arrangements.

4. The article of manufacture of claim 2, wherein the attributes, the inputs, and the technical descriptors are associated with one or more validation criteria and each validation criteria corresponds to a group comprising one or more of the attributes, the converted technical descriptors, and the inputs.

5. The article of manufacture of claim 4, wherein each sequential arrangement corresponds to a validation criterion.

6. The article of manufacture of claim 1, wherein the one or more configurations correspond to configuration of an entitlement

7. The article of manufacture of claim 6, wherein the technical descriptors comprise operations to establishing logic for configuring the entitlement.

8. A computerized method for verifying configurations, the method comprising:
receiving attributes, inputs, and technical descriptors of one or more configurations in response to configuring operations performed by a user on one or more user interfaces;
converting the received technical descriptors into natural language words;
generating a report comprising a coherent arrangement of the received attributes, the received inputs, and the converted technical descriptors to enable reading of the configurations; and
presenting the generated report on a user interface.

9. The method of claim 8, wherein the coherent arrangement comprises a plurality of sequential arrangements, where each sequential arrangement comprises an attribute followed by a corresponding converted technical descriptor and a corresponding validation criterion.

10. The method of claim 9, wherein one or more of the converted technical descriptors are used to establish a relation between the plurality of sequential arrangements.

11. The method of claim 9, wherein the attributes, the inputs, and the technical descriptors are associated with one or more validation criteria and each validation criteria corresponds to a group comprising one or more of the attributes, the converted technical descriptors, and the inputs.

12. The method of claim 11, wherein each sequential arrangement corresponds to a validation criterion.

13. The method of claim 8, wherein the one or more configurations correspond to configuration of an entitlement.

14. The method of claim 13, wherein the technical descriptors comprise operations to establishing logic for configuring the entitlement.

15. A computer system for verifying configurations, comprising:
a computer memory to store program code; and
a processor to execute the program code to:
receive attributes, inputs, and technical descriptors of one or more configurations in response to configuring operations performed by a user on one or more user interfaces;
convert the received technical descriptors into natural language words;
generate a report comprising a coherent arrangement of the received attributes, the received inputs, and the converted technical descriptors to enable reading of the configurations; and
present the generated report on a user interface.

16. The system of claim 15, wherein the coherent arrangement comprises a plurality of sequential arrangements, where each sequential arrangement comprises an attribute followed by a corresponding converted technical descriptor and a corresponding validation criterion.

17. The system of claim 16, wherein one or more of the converted technical descriptors are used to establish a relation between the plurality of sequential arrangements.

18. The system of claim 16, wherein the attributes, the inputs, and the technical descriptors are associated with one or more validation criteria and each validation criteria corresponds to a group comprising one or more of the attributes, the converted technical descriptors, and the inputs.

19. The system of claim 18, wherein each sequential arrangement corresponds to a validation criterion.

20. The system of claim 15, wherein the one or more configurations correspond to configuration of an entitlement.

21. The system of claim 20, wherein the technical descriptors comprise operations to establishing logic for configuring the entitlement.
